(19) United States
(12) Patent Application Publication
(10) Pub. No.: US 2026/0282006 A1
(43) Pub. Date: Sep. 17, 2026

(54) HYBRID AUTOMATIC REPEAT REQUEST (HARQ) MODE AND DISCONTINUOUS RECEPTION (DRX) TIMER OPERATION METHOD AND DEVICE FOR EXTREME REALITY (XR)

(71) Applicant: Samsung Electronics Co., Ltd., Gyeongg-do (KR)

(72) Inventors: Sangkyu BAEK, Gyeonggi-do (KR); Hyunjeong KANG, Gyeonggi-do (KR)

(21) Appl. No.: 19/472,261

(22) PCT Filed: Apr. 4, 2024
(86) PCT No.: PCT/KR2024/004394

§ 371 Date: Oct. 3, 2025

(30) Foreign Application Priority Data
Apr. 4, 2023 (KR) 10-2023-0044310

(51) Int. Cl. H04W 72/1263; H04L 1/1829; H04W 76/28

(52) U.S. Cl. CPC H04W 72/1263; H04L 1/1848; H04W 76/28

(57) ABSTRACT

The disclosure relates to a 5G or 6G communication system for supporting a higher data transmission rate. According to the present disclosure, when a configured grant is set, a terminal and a base station can efficiently transmit and receive data even when data to be transmitted from a CG resource has a short transmission time requirement.

### TECHNICAL FIELD

The disclosure relates to operations of a terminal and a base station in a mobile communication system. Particularly, the disclosure relates to operations of a terminal and a base station in a mobile communication system, and particularly, to a method and a device for, when a configured grant is configured, transmitting data which is to be transmitted in a CG resource and has a short transmission time requirement.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC). there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Meanwhile, there is a need for a solution to overcome a problem that, when a configured grant is configured, may occur in transmitting data which is to be transmitted in a CG resource and has a short transmission time requirement.

### DISCLOSURE

### Technical Problem

The purpose of the disclosure is to provide a method and a device for solving a problem that, when a configured grant is configured for a terminal, may occur in transmitting data which is to be transmitted in a CG resource and has a short transmission time requirement.

### Technical Solution

A method performed by a terminal in a wireless communication system according to an embodiment of the disclosure for solving the above-mentioned problem may include: receiving a control message including configured grant (CG) configuration information from a base station; identifying that information indicating deactivation of retransmission monitoring is configured, based on the CG configuration information; receiving information on an uplink transmission through a physical downlink control channel (PDCCH), wherein the information on the uplink transmission is associated with a configured scheduling-radio network temporary identifier (CS-RNTI) having a new data indicator (NDI) set to 0; and driving a discontinuous reception (DRX)-hybrid automatic repeat request (HARQ)-round trip time (RTT) timer after a first uplink data transmission based on the information received through the PDCCH.

A terminal in a wireless communication system according to another embodiment of the disclosure may include: a transceiver; and a controller configured to perform control to receive, through the transceiver, a control message including configured grant (CG) configuration information from a base station, identify that information indicating deactivation of retransmission monitoring is configured, based on the CG configuration information, receive, through a physical downlink control channel (PDCCH), information on an uplink transmission, wherein the information on the uplink transmission is associated with a configured scheduling-radio network temporary identifier (CS-RNTI) having a new data indicator (NDI) set to 0, and drive a discontinuous reception (DRX)-hybrid automatic repeat request (HARQ)-round trip time (RTT) timer after a first uplink data transmission based on the information received through the PDCCH.

### Advantageous Effects

According to an embodiment of the disclosure, when a configured grant is configured, data to be transmitted in a CG resource may be efficiently transmitted and received even when the data has a short transmission time requirement.

### DESCRIPTION OF DRAWINGS

FIG. 1 is a diagram illustrating a configured grant transmission operation scheme according to an embodiment of the disclosure.

FIG. 2 is a diagram illustrating a configured grant transmission operation scheme according to an embodiment of the disclosure.

FIG. 3 is a diagram illustrating a configured grant transmission operation scheme according to an embodiment of the disclosure.

FIG. 4 is a diagram illustrating a terminal operation scheme according to PDCCH scheduling according to an embodiment of the disclosure.

FIG. 5 is a diagram illustrating a terminal operation scheme according to a transmission using a CG resource according to an embodiment of the disclosure.

FIG. 6 is a diagram illustrating a configured grant transmission operation scheme according to an embodiment of the disclosure.

FIG. 7 is a diagram illustrating a terminal operation scheme according to a transmission using a CG resource according to an embodiment of the disclosure.

FIG. 8 is a diagram illustrating a terminal operation scheme according to a transmission using a CG resource according to an embodiment of the disclosure.

FIG. 9 is a diagram illustrating a configured grant transmission operation scheme according to an embodiment of the disclosure.

FIG. 10 is a diagram illustrating a configured grant transmission operation scheme according to an embodiment of the disclosure

FIG. 11 is a diagram illustrating a configured grant transmission operation scheme according to an embodiment of the disclosure.

FIG. 12 is a diagram illustrating a logical channel prioritization (LCP) restriction change operation scheme according to an embodiment of the disclosure.

FIG. 13 illustrates a structure of a base station according to an embodiment of the disclosure.

FIG. 14 illustrates a structure of a UE according to an embodiment of the disclosure.

### MODE FOR INVENTION

Hereinafter, the operation principle of the disclosure will be described in detail in conjunction with the accompanying drawings. In addition, a detailed description of known functions or configurations that may make the subject matter of the disclosure unclear will be omitted. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B. a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include the 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description of the disclosure, terms and names defined in 5GS and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards).

In describing the disclosure below, a detailed description of known functions or configurations will be omitted when it is determined that the description may make the subject matter of the disclosure unnecessarily unclear. Hereinafter, embodiments of the disclosure will be described with reference to the accompanying drawings.

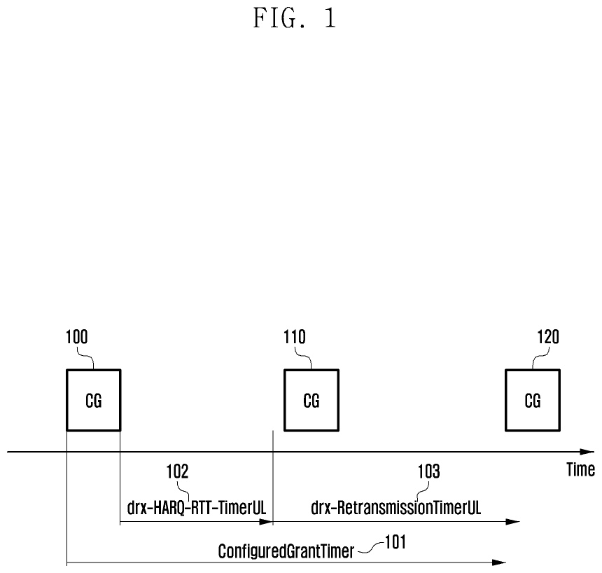

FIG. 1 is a diagram illustrating a configured grant transmission operation scheme according to an embodiment of the disclosure.

In a wireless communication system, an uplink radio resource (uplink grant) transmitted by a UE to a base station may be classified as a dynamic grant (DG) and a configured grant (CG) according to a resource allocation scheme. The DG is a radio resource in which the base station designates a location of a resource through a downlink control information (DCI) message on a physical downlink control channel (PDCCH) physical channel, and indicates a single-use resource. The CG is a radio resource in which a period is configured by the base station through a radio resource control (RRC) message and which is repeated at a predetermined period. The CG is classified into a first type (Type-1) CG which is activated immediately when configured by an RRC message depending on a type, and a second type (Type-2) CG which is configured by an RRC message and then activated by configuring a location of a first resource on a PDCCH physical channel through a DCI message by using a configured scheduling-radio network temporary identity (CS-RNTI). When the second type CG is activated, it may have a format in which resources are periodically repeated based on a first configured resource. The first resource indicated when the second type CG is activated is an uplink radio resource for which a location of the resource is indicated through a PDCCH physical channel. Accordingly, the resource has a characteristic of a DG, and since it is also a part of a CG configuration in which subsequent resources are periodically repeated, the resource has a characteristic of a CG as well.

The embodiment of FIG. 1 illustrates that a CG resource 100, 110, or 120 periodically configured is repeated, and the CG resource 100, 110, or 120 is used for transmission. Using the CG resource for transmission means that the UE transmits data, which is referred to as a medium access control protocol data unit (MAC PDU) or a transport block (TB), to the base station by using the CG resource. When the UE transmits a MAC PDU to the base station by using a CG resource in this manner, a MAC layer of the UE may deliver a MAC PDU to be transmitted to an HARQ process, may indicate the corresponding HARQ process to trigger a new transmission, and may start a ConfiguredGrantTimer 101 at a start time point of a first symbol of a physical uplink shared channel (PUSCH) on which the CG is transmitted. While the ConfiguredGrantTimer 101 is running, no other CG transmission using the same HARQ process is performed. Accordingly, during the operation of the ConfiguredGrantTimer 101, a retransmission resource of a CG transmitted by the base station may be allocated by using a CS-RNTI. In the embodiment of FIG. 1, it is assumed that the length of the ConfiguredGrantTimer 101 is twice the length of a CG period, but the length of the ConfiguredGrantTimer 101 may be configured for the UE by the base station through an RRC message.

When the UE transmits a MAC PDU on the uplink through a CG, a drx-HARQ-RTT-TimerUL 102 may be started according to a discontinuous reception (DRX) scheme configured to reduce UE power consumption. The drx-HARQ-RTT-TimerUL 102 may be started only when an actual CG transmission is performed and, in the case of an unlicensed band, when a listen before talk (LBT) failure is not delivered from a lower layer. In this case, a time point at which the drx-HARQ-RTT-TimerUL 102 starts may be a first symbol immediately after an end time point of a PUSCH in which the CG transmission is performed. If a CG bundle is configured and a CG resource is repeated by using multiple PUSCH physical channels, the drx-HARQ-RTT-TimerUL 102 may be started at a first symbol immediately after a time point at the end of a corresponding bundle transmission, based on the first transmission or the last transmission of the bundle depending on whether drx-LastTransmissionUL is configured. The drx-HARQ-RTT-TimerUL 102 may be generally configured as a minimum time required for the base station to indicate a retransmission resource through a PDCCH physical channel when reception fails after decoding a CG resource received from the UE. After the drx-HARQ-RTT-TimerUL 102 expires, the UE may start a drx-RetransmissionTimerUL 103. A time during which the drx-Retransmission TimerUL 103 operates is considered as an active time of a corresponding DRX group, and during this time, a MAC entity of the UE is required to perform PDCCH monitoring.

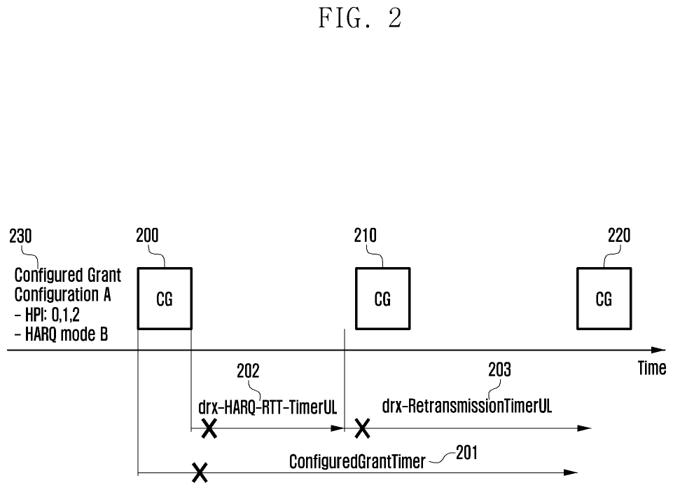

FIG. 2 is a diagram illustrating a configured grant transmission operation scheme according to an embodiment of the disclosure.

A configuration for a CG, excluding information on a location of a resource configured when the CG is activated, may be included in CG Config of an RRC message and transmitted by a base station to a UE. When data to be transmitted by a configured CG resource has a short transmission time requirement such as in motion control, high-speed multimedia, extreme reality (XR), or ultra-reliability and low latency communications (URLLC), performing retransmission after transmission through the CG may not satisfy the transmission time requirement. In this case, the base station may not allocate a retransmission resource so that the UE does not perform retransmission after CG transmission.

Since whether to allocate a retransmission resource and a retransmission time point are determined by the base station, the UE is required to start a ConfiguredGrantTimer 201 in preparation for retransmission by the base station. If the base station does not perform retransmission for a specific CG, the UE does not need to start the ConfiguredGrantTimer 201, To this end, the base station may configure whether to start the ConfiguredGrantTimer 201 after CG transmission for a specific CG. When such a configuration is set for each CG, whether to start the ConfiguredGrantTimer 201 after the CG transmission may be configured in the CG config. Further, at the time of transmission of a CG resource corresponding to the CG configuration, whether to start the ConfiguredGrantTimer 201 may be applied to all HARQ processes used for the CG transmission. In another embodiment, whether to start the ConfiguredGrantTimer 201 after the CG transmission may be configured for each HARQ process. For example, the ConfiguredGrantTimer may be configured not to be started after CG transmission corresponding to HARQ process ID 2 and HARQ process ID 3 of SCell 1. In this case, whether to start the ConfiguredGrantTimer at the time of CG transmission for each HARQ process may be configured in PUSCH-ServingCellConfig. Such an HARQ process that is configured not to start the ConfiguredGrantTimer after CG transmission may be referred to as a Mode B HARQ process. Subsequently, when a MAC PDU is transmitted to the base station by using a predetermined CG resource 200, a MAC layer of the UE may deliver a MAC PDU to be transmitted to an HARQ process, may indicate the corresponding HARQ process to trigger a new transmission, and, if the CG or the HARQ process corresponding to the CG is configured not to start the ConfiguredGrantTimer, may refrain from starting the ConfiguredGrantTimer 201 at a start time point of a first symbol of a physical uplink shared channel (PUSCH) on which the CG is transmitted. If the CG or the HARQ process corresponding to the CG is configured to start the ConfiguredGrantTimer 201, the ConfiguredGrantTimer 201 may be started at the start time point of the first symbol of the physical uplink shared channel (PUSCH) on which the CG is transmitted. The configuration for not starting the ConfiguredGrantTimer 201 after CG transmission may also be applied to a first CG resource which indicates activation of the CG resource on a PDCCH physical channel by using an uplink CG radio resource and a CS-RNTI and for which a location of the resource is configured.

Since whether to allocate a retransmission resource and a retransmission time point are determined by the base station, the UE is required to start a drx-HARQ-RTT-TimerUL 202 in preparation for retransmission by the base station. If the base station does not perform retransmission for a specific CG, the UE does not need to start the drx-HARQ-RTT-TimerUL 202. If the UE does not start a drx-HARQ-RTT-TimerUL 202, the UE does not start a drx-RetransmissionTimerUL 203 thereafter, thereby reducing power consumption of the UE. To this end, the base station may configure, for the UE, whether to start the drx-HARQ-RTT-TimerUL 202 after CG transmission for a specific CG. When such a configuration is set for each CG, whether to start the drx-HARQ-RTT-TimerUL 202 after the CG transmission may be configured in the CG config, and whether to start the drx-HARQ-RTT-TimerUL 202 may be applied to all HARQ processes used for the CG transmission at the time of transmission of a CG resource corresponding to the CG configuration. In another embodiment, whether to start the drx-HARQ-RTT-TimerUL 202 after the CG transmission may be configured for each HARQ process. For example, the drx-HARQ-RTT-TimerUL 202 may be configured not to be started after CG transmission corresponding to HARQ process ID 2 and HARQ process ID 3 of SCell 1. In this case, whether to start the drx-HARQ-RTT-TimerUL 202 at the time of CG transmission for each HARQ process may be configured in PUSCH-ServingCellConfig. Such an HARQ process that is configured not to start the drx-HARQ-RTT-TimerUL 202 after CG transmission may be referred to as a Mode B HARQ process. When the MAC PDU is actually transmitted to the base station by using the CG resource 200, the MAC layer of the UE may deliver the MAC PDU to be transmitted to an HARQ process, may indicate the corresponding HARQ process to trigger a new transmission, and, if the CG or the HARQ process corresponding to the CG is configured not to start the drx-HARQ-RTT-TimerUL 202, may refrain from starting the drx-HARQ-RTT-TimerUL 202 at a first symbol immediately after an end time point of the PUSCH in which the CG transmission is performed. If the CG or the HARQ process corresponding to the CG is configured to start the drx-HARQ-RTT-TimerUL 202, the drx-HARQ-RTT-TimerUL 202 may be started at the first symbol immediately after the end time point of the PUSCH in which the CG transmission is performed. Thereafter, the UE may start a drx-Retransmission TimerUL 203 at a time point when the drx-HARQ-RTT-TimerUL 202 expires, and may identify whether the base station indicates retransmission. The configuration for not starting the drx-HARQ-RTT-TimerUL 202 after CG transmission may also be applied to a first CG resource which indicates activation of the CG resource on a PDCCH physical channel by using an uplink CG radio resource and a CS-RNTI and for which a location of the resource is configured. In some embodiments, whether to start the ConfiguredGrantTimer and the drx-HARQ-RTT-TimerUL after CG transmission may be delivered by the base station to the UE by using one common configuration value.

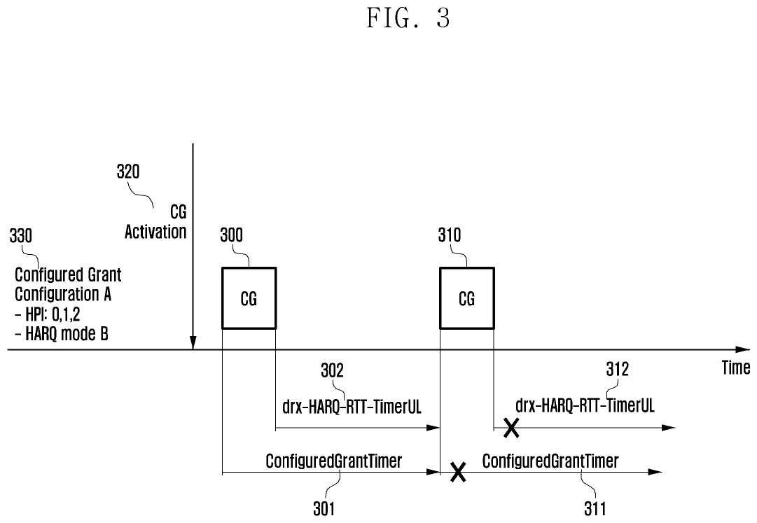

FIG. 3 is a diagram illustrating a configured grant transmission operation scheme according to an embodiment of the disclosure.

A configuration for a CG, excluding information on a location of a resource configured when the CG is activated, may be included in CG Config of an RRC message and transmitted by a base station to a UE. When data to be transmitted by a configured CG resource has a short transmission time requirement such as in motion control, high-speed multimedia, extreme reality (XR), or ultra-reliability and low latency communications (URLLC), performing retransmission after transmission through the CG may not satisfy the transmission time requirement. In this case, the base station may not allocate a retransmission resource so that the UE does not perform retransmission after CG transmission. However, when a CG resource is activated by using a CS-RNTI (new data indicator (NDI)=0) on a PDCCH (320), an uplink radio resource allocated in this manner may be configured to transmit, through the CG resource, a configured grant confirmation (CGC) MAC control element (CE), indicating that a CG resource activation indication has been received and applied. Since the base station needs to receive the CGC message in order to recognize that the UE has completed activation of the CG resource, retransmission may need to be performed for a first CG resource including the CGC message. Even when a ConfiguredGrantTimer or a drx-HARQ-RTT-TimerUL for a corresponding HARQ process is configured not to be started at the time of transmission of the corresponding CG resource, a ConfiguredGrantTimer 301 or a drx-HARQ-RTT-TimerUL 302 may need to be started for the first CG resource indicated by the PDCCH by using the CS-RNTI (NDI=0).

In the embodiment of FIG. 3, it is assumed that HARQ process IDs (HPIs) available when CG A is configured are set to 0, 1, and 2, and that HARQ mode B, in which the ConfiguredGrantTimer is not started or the drx-HARQ-RTT-TimerUL is not started, is configured at the time of CG transmission (330). Thereafter, when a resource of the corresponding CG is activated by the PDCCH, the UE may perform a first CG transmission 300 and start the ConfiguredGrantTimer 301 at a start time point of a first symbol on which the CG 300 is transmitted. In addition, when the resource of the CG is activated by the PDCCH, the UE may perform the first CG transmission 300 and start the drx-HARQ-RTT-TimerUL 302 at a first symbol immediately after an end time point of a PUSCH in which the CG transmission 300 is performed. If a CG bundle is configured and a CG resource is repeated by using multiple PUSCH physical channels, the drx-HARQ-RTT-TimerUL 302 may be started at a first symbol immediately after a time point at the end of a corresponding bundle transmission, based on the first transmission or the last transmission of the bundle depending on whether drx-LastTransmissionUL is configured.

In the case of a CG resource that is not a first resource activated by the PDCCH, since the resource is a resource that is repeated without an indication on the PDCCH, a ConfiguredGrantTimer 311 or a drx-HARQ-RTT-TimerUL 312 may not be started at the time of the next CG transmission 310 according to a configuration of the CG configured by the RRC message (330).

Since whether to allocate a retransmission resource and a retransmission time point are determined by the base station, the UE is required to start a ConfiguredGrantTimer in preparation for retransmission by the base station. If the base station does not perform retransmission for a specific CG, the UE does not need to start the ConfiguredGrantTimer. To this end, the base station may configure whether to start the ConfiguredGrantTimer after CG transmission for a specific CG. When such a configuration is set for each CG, whether to start the ConfiguredGrantTimer after the CG transmission may be configured in the CG config, and whether to start the ConfiguredGrantTimer may be applied to all HARQ processes used for the CG transmission at the time of transmission of a CG resource corresponding to the CG configuration. In another embodiment, whether to start the ConfiguredGrantTimer after the CG transmission may be configured for each HARQ process. For example, the ConfiguredGrantTimer may be configured not to be started after CG transmission corresponding to HARQ process ID 2 and HARQ process ID 3 of SCell 1. In this case, the base station may configure, in the PUSCH-ServingCellConfig, whether to start the ConfiguredGrantTimer at the time of CG transmission for each HARQ process. Such an HARQ process that is configured not to start the ConfiguredGrantTimer after CG transmission may be referred to as a Mode B HARQ process. Thereafter, when a MAC PDU is actually transmitted to the base station by using a CG resource 310, a MAC layer of the UE may deliver a MAC PDU to be transmitted to an HARQ process, and may indicate the corresponding HARQ process to trigger a new transmission. When the CG 310 or an HARQ process corresponding to the CG 310 is configured not to start the ConfiguredGrantTimer, the ConfiguredGrantTimer 311 may not be started at a start time point of a first symbol of the PUSCH on which the CG 310 is transmitted. When the CG 310 or the HARQ process corresponding to the CG 310 is configured to start the ConfiguredGrantTimer, the ConfiguredGrantTimer 311 may be started at the start time point of the first symbol of the PUSCH on which the CG is transmitted.

Since whether to allocate a retransmission resource and a retransmission time point are determined by the base station, the UE is required to start a drx-HARQ-RTT-TimerUL in preparation for retransmission by the base station. If the base station does not perform retransmission for a specific CG, the UE does not need to start the drx-HARQ-RTT-TimerUL. If the UE does not start the drx-HARQ-RTT-TimerUL, the UE does not start a drx-RetransmissionTimerUL thereafter, thereby reducing power consumption of the UE. To this end, the base station may configure whether to start the drx-HARQ-RTT-TimerUL after CG transmission for a specific CG. When such a configuration is set for each CG, the base station may configure, in the CG Config, whether to start the drx-HARQ-RTT-TimerUL after the CG transmission, and may apply the configuration on whether to start the drx-HARQ-RTT-TimerUL to all HARQ processes used for the CG transmission at the time of transmission of a CG resource corresponding to the CG configuration. In another embodiment, whether to start the drx-HARQ-RTT-TimerUL after the CG transmission may be configured for each HARQ process. For example, the drx-HARQ-RTT-TimerUL may be configured not to be started after CG transmission corresponding to HARQ process ID 2 and HARQ process ID 3 of SCell 1. In this case, whether to start the drx-HARQ-RTT-TimerUL at the time of CG transmission for each HARQ process may be configured in PUSCH-ServingCellConfig. Such an HARQ process that is configured not to start the drx-HARQ-RTT-TimerUL after CG transmission may be referred to as a Mode B HARQ process. Thereafter, when the MAC PDU is actually transmitted to the base station by using the CG resource 310, the MAC layer of the UE may deliver a MAC PDU to be transmitted to an HARQ process, and may indicate the corresponding HARQ process to trigger a new transmission. If the CG or the HARQ process corresponding to the CG is configured not to start the drx-HARQ-RTT-TimerUL, the UE may not start a drx-HARQ-RTT-TimerUL 312 at a first symbol immediately after an end time point of the PUSCH in which the CG transmission is performed. If the CG or the HARQ process corresponding to the CG is configured to start the drx-HARQ-RTT-TimerUL, the UE may start the drx-HARQ-RTT-TimerUL at the first symbol immediately after the end time point of the PUSCH in which the CG transmission is performed. Thereafter, the UE may start the drx-Retransmission TimerUL at a time point when the drx-HARQ-RTT-TimerUL expires. and may identify whether the base station indicates retransmission. In some embodiments, whether to start the ConfiguredGrantTimer and the drx-HARQ-RTT-TimerUL after CG transmission may be delivered by the base station to the UE by using one common configuration value.

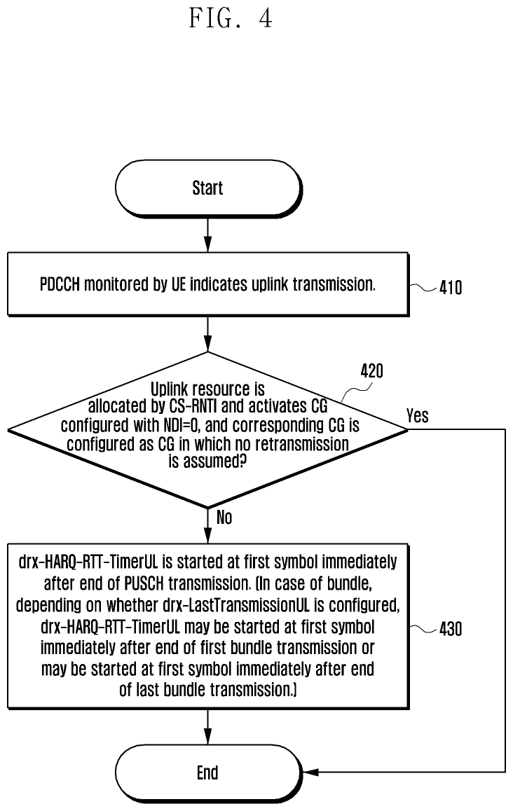

FIG. 4 is a diagram illustrating a UE operation scheme according to PDCCH scheduling according to an embodiment of the disclosure.

A UE may monitor a PDCCH physical channel by using an RNTI, such as a C-RNTI or a CS-RNTI, configured for the UE. According to an embodiment, if DRX is configured in a DRX group configured for the UE, the UE may perform PDCCH monitoring only in an active time period of the DRX.

According to the embodiment of FIG. 4, in step 410, an uplink transmission may be indicated on a PDCCH monitored by the UE. Indicating an uplink transmission on the PDCCH may be considered as DG transmission, but may also include a case of activating a second type uplink CG and indicating transmission of a first CG resource. In this case, the UE may determine whether to start a drx-HARQ-RTT-TimerUL according to the characteristics of an uplink transmission resource indicated on the PDCCH. For example, in step 420, the UE may identify whether the uplink transmission indicated on the PDCCH is an uplink radio resource allocated by a CS-RNTI and configured with NDI=0, and identify whether this represents a first CG transmission by activation of a second type CG, and whether a CG is configured not to start the drx-HARQ-RTT-TimerUL. The CG configured not to start the drx-HARQ-RTT-TimerUL may indicate that a base station does not allow the UE to perform retransmission for the corresponding CG. In step 420, if the uplink transmission indicated on the PDCCH is an uplink radio resource allocated by a CS-RNTI and configured with NDI=0, and this represents a first CG transmission by activation of a second type CG and is a CG configured not to start the drx-HARQ-RTT-TimerUL (if a CG in which no retransmission is assumed or an HARQ process corresponding to the corresponding CG is configured to HARQ mode B), a MAC layer of the UE may perform transmission of the corresponding CG resource and may not start the drx-HARQ-RTT-TimerUL. In step 420, if the uplink transmission indicated on the PDCCH is an uplink radio resource allocated by a CS-RNTI and configured with NDI=0, and this represents a first CG transmission by activation of a second type CG and is not a CG configured not to start the drx-HARQ-RTT-TimerUL, the drx-HARQ-RTT-TimerUL may be started at a first symbol immediately after the end of a corresponding PUSCH transmission. If the CG is a bundle, the drx-HARQ-RTT-TimerUL may be started at a first symbol immediately after the end of the first bundle transmission or at a first symbol immediately after the end of the last bundle transmission depending on whether drx-LastTransmissionUL is configured (step 430).

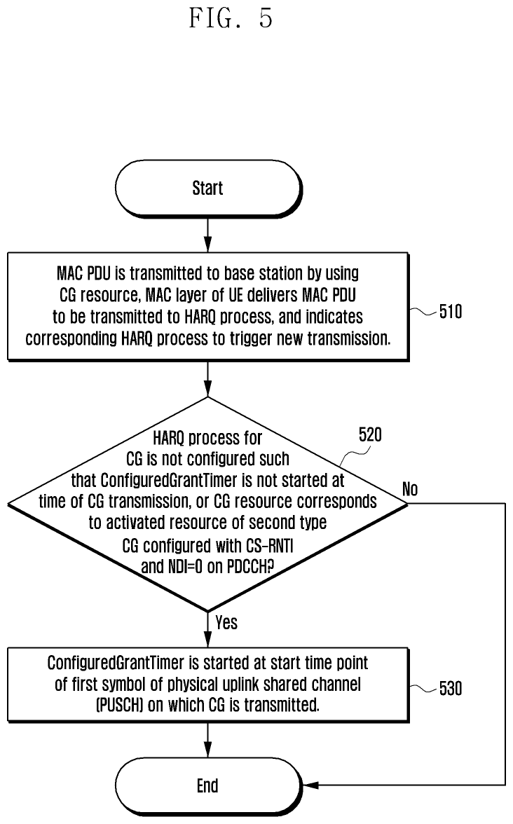

FIG. 5 is a diagram illustrating a UE operation scheme according to a transmission using a CG resource according to an embodiment of the disclosure.

According to an embodiment of FIG. 5, in step 510, when a MAC PDU is actually transmitted to a base station by using a CG resource, a MAC layer of a UE may deliver a MAC PDU to be transmitted to an HARQ process, and may indicate the corresponding HARQ process to trigger a new transmission.

In this case, in step 520, whether an HARQ process for the CG is not configured such that a ConfiguredGrantTimer is not started at the time of the CG transmission or whether the CG resource corresponds to an activated resource of a second type CG configured with a CS-RNTI and NDI=0 on a PDCCH may be identified. If the HARQ process for the CG is not configured such that the ConfiguredGrantTimer is not started at the time of the CG transmission, or if the CG resource corresponds to the activated resource of the second type CG configured with the CS-RNTI and NDI=0 on the PDCCH, the ConfiguredGrantTimer may be started at a start time point of a first symbol of a PUSCH on which the CG is transmitted. In addition, a cg-RetransmissionTimer may also be started at the same time point (for example, at a time point when the ConfiguredGrantTimer is started) (step 530). For example, in the case of the activated resource of the second type CG, the ConfiguredGrantTimer may be always started regardless of a configuration of whether to start the ConfiguredGrantTimer, so that a retransmission time for the corresponding CG may be secured. Therefore, the base station may request a retransmission for a CG transmission in which a CGC MAC CE may be included. In step 520, if the HARQ process for the CG is configured such that the ConfiguredGrantTimer is not started at the time of the CG transmission, or if the CG resource does not correspond to the activated resource of the second type CG configured with the CS-RNTI and NDI=0 on the PDCCH, the ConfiguredGrantTimer may be started at the start time point of the first symbol of the PUSCH on which the CG is transmitted. In addition, the cg-RetransmissionTimer may not be started at the same time point (for example, the start time point of the first symbol of the PUSCH on which the CG is transmitted).

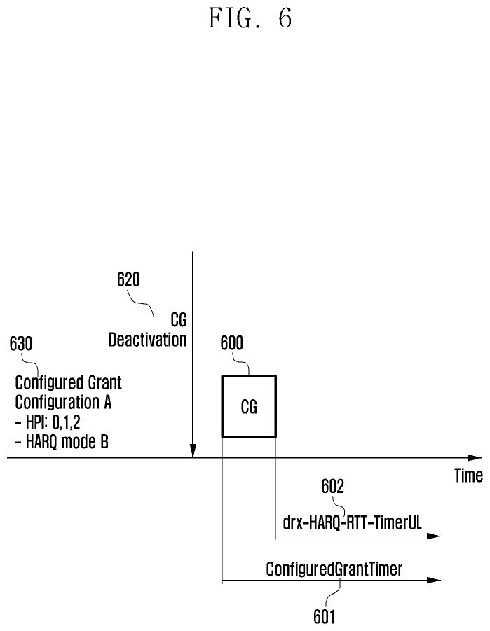

FIG. 6 is a diagram illustrating a configured grant transmission operation scheme according to an embodiment of the disclosure.

A configuration for a CG, excluding information on a location of a resource configured when the CG is activated, may be included in CG Config of an RRC message and transmitted by a base station to a UE. When data to be transmitted by a configured CG resource has a short transmission time requirement such as in motion control, high-speed multimedia, extreme reality (XR), or ultra-reliability and low latency communications (URLLC), performing retransmission after transmission through the CG may not satisfy the transmission time requirement. In this case, the base station may not allocate a retransmission resource so that the UE does not perform retransmission after CG transmission. However, when a CG resource is deactivated by using a CS-RNTI (NDI=0) on a PDCCH (620), the UE may transmit, through the CG resource, a configured grant confirmation (CGC) MAC control element (CE) indicating that the UE has received and applied a deactivation indication for the CG resource with respect to an uplink radio resource allocated in this manner. Since the base station needs to receive the CGC message in order to recognize that the UE has completed the deactivation of the CG resource, retransmission may need to be performed for a first CG resource including the CGC message. Then, the UE may actually apply the deactivation of the corresponding CG immediately after transmitting the CGC message, so as to clear the corresponding CG resource. Even when a ConfiguredGrantTimer or a drx-HARQ-RTT-TimerUL for a corresponding HARQ process is configured not to be started at the time of transmission of the corresponding CG resource, the UE may need to start a ConfiguredGrantTimer 601 or a drx-HARQ-RTT-TimerUL 602 for a resource for which the PDCCH indicates deactivation of the CG by using CS-RNTI (NDI=0) and for which the CGC message is transmitted.

In the embodiment of FIG. 6, it is assumed that HARQ process IDs (HPIs) available when CG A is configured are set to 0, 1, and 2, and that HARQ mode B, in which the ConfiguredGrantTimer is not started or the drx-HARQ-RTT-TimerUL is not started, is configured at the time of CG transmission (630). Thereafter, when a resource of the corresponding CG is deactivated by the PDCCH and the UE is unable to transmit the CGC message on another radio resource, the UE may perform transmission of the CG resource on the CG resource 600. In this case, the UE may start the ConfiguredGrantTimer 601 at a start time point of a first symbol on which the CG resource is transmitted. In addition, when the resource of the CG is deactivated by the PDCCH, the UE may perform a first CG transmission 600 and start the drx-HARQ-RTT-TimerUL 602 at a first symbol immediately after an end time point of a PUSCH in which the CG transmission 600 is performed. If a CG bundle is configured and a CG resource is repeated by using multiple PUSCH physical channels, the UE may start the drx-HARQ-RTT-TimerUL at a first symbol immediately after a time point at the end of a corresponding bundle transmission, based on the first transmission or the last transmission of the bundle depending on whether drx-LastTransmissionUL is configured.

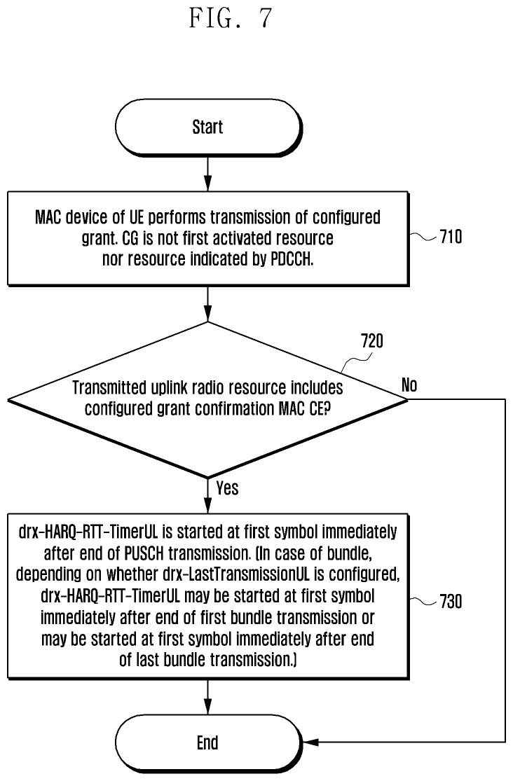

FIG. 7 is a diagram illustrating a UE operation scheme according to a transmission using a CG resource according to an embodiment of the disclosure.

In the embodiment of FIG. 7, it is assumed that when a MAC PDU is actually transmitted to a base station by using a CG resource, a MAC layer of a UE delivers a MAC PDU to be transmitted to an HARQ process, and indicates the corresponding HARQ process to trigger a new transmission. The CG resource used may be a first resource of an activated CG for which an uplink transmission is indicated by a PDCCH using a CS-RNTI, or a CG resource that is not indicated by the PDCCH (step 710). In addition, it is assumed that the CG resource or an HARQ process used by the CG resource is configured by the base station such that a drx-HARQ-RTT-TimerUL is not started. In this case, the UE may identify whether a CGC MAC CE is included in and transmitted using the CG resource (step 720). If the CGC MAC CE is included in and transmitted using the CG resource, the base station may need to request retransmission of the corresponding CG resource in order to receive the CGC MAC CE included in the CG. The base station is unable to recognize whether the CGC MAC CE is included in the CG resource until it is successfully received, but since the UE is required to transmit a CGC MAC CE when the CG is activated or deactivated, the base station may estimate the location of the CG resource that is expected to include the CGC MAC CE. In order to perform such retransmission, a MAC device of the UE may start the drx-HARQ-RTT-TimerUL at a first symbol immediately after the end of a corresponding PUSCH transmission. If the CG is a bundle, the UE may start the drx-HARQ-RTT-TimerUL at a first symbol immediately after the end of the first bundle transmission or at a first symbol immediately after the end of the last bundle transmission depending on whether drx-LastTransmissionUL is configured (step 730). In step 720, if the CGC MAC CE is not included in the transmission using the CG resource, the UE may perform transmission of the corresponding CG resource and may not start the drx-HARQ-RTT-TimerUL.

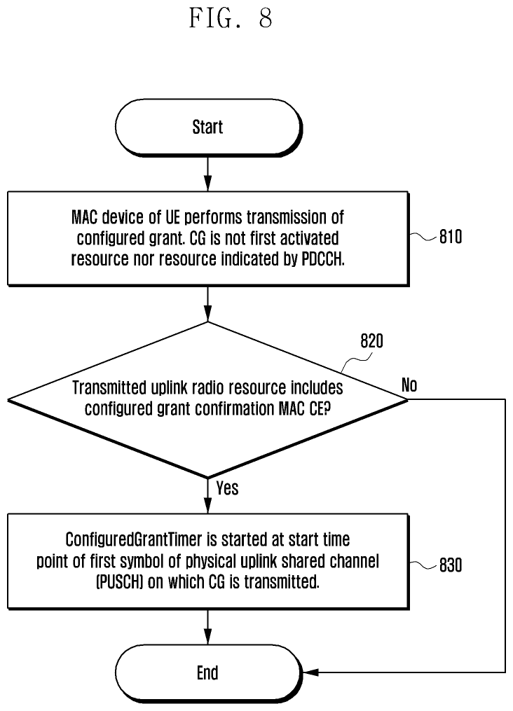

FIG. 8 is a diagram illustrating a UE operation scheme according to a transmission using a CG resource according to an embodiment of the disclosure.

In the embodiment of FIG. 8, it is assumed that when a MAC PDU is actually transmitted to a base station by using a CG resource, a MAC layer of a UE delivers a MAC PDU to be transmitted to an HARQ process, and indicates the corresponding HARQ process to trigger a new transmission. The CG resource used may be a first resource of an activated CG for which an uplink transmission is indicated by a PDCCH using a CS-RNTI, or a CG resource that is not indicated by the PDCCH (step 810). In addition, it is assumed that the CG resource or an HARQ process used by the CG resource is configured by the base station such that a ConfiguredGrantTimer is not started. In this case, the UE may identify whether a CGC MAC CE is included in and transmitted using the CG resource (820). If the CGC MAC CE is included in and transmitted using the CG resource, the UE may start the ConfiguredGrantTimer at a start time point of a first symbol of a PUSCH on which the CG is transmitted. In addition, the UE may also start a cg-Retransmission Timer at the same time point (for example, at a time point when the ConfiguredGrantTimer is started) (step 830). For example, in the case of an activated resource of a second type CG, the UE may always start the ConfiguredGrantTimer regardless of a configuration of whether to start the ConfiguredGrantTimer, so that a retransmission time for the corresponding CG may be secured. Therefore, the base station may request a retransmission for a CG transmission in which a CGC MAC CE may be included. In step 820, if the CGC MAC CE is not included in the transmission using the CG resource, the UE may not start the ConfiguredGrantTimer at the first symbol of the PUSCH on which the CG is transmitted. In addition, the UE may not start the cg-Retransmission Timer at the same time point (for example, at a time point when the ConfiguredGrantTimer is started).

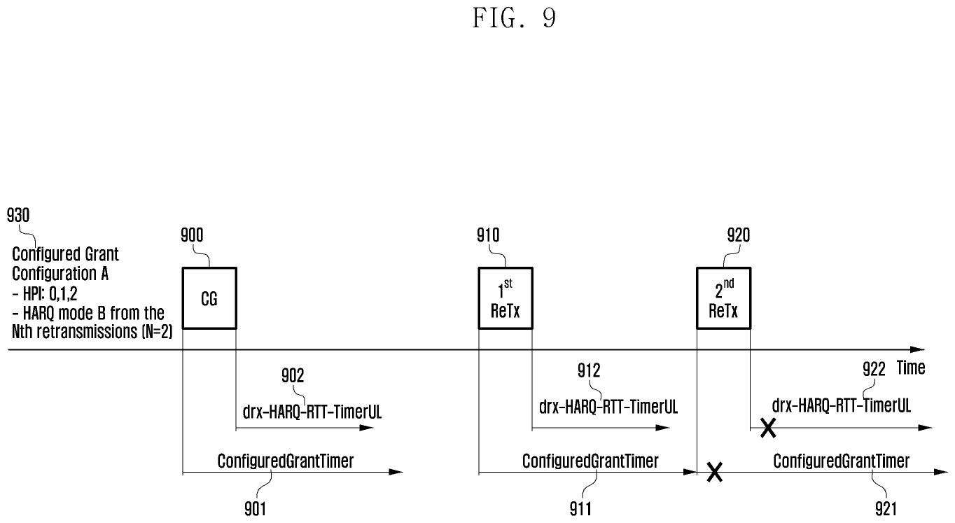

FIG. 9 is a diagram illustrating a configured grant transmission operation scheme according to an embodiment of the disclosure.

A configuration for a CG, excluding information on a location of a resource configured when the CG is activated, may be included in CG Config of an RRC message and transmitted by a base station to a UE. When data to be transmitted by a configured CG resource has a short transmission time requirement such as in motion control, high-speed multimedia, XR, or URLLC, performing retransmission after transmission through the CG may not satisfy the transmission time requirement. In this case, the base station may not allocate a retransmission resource so that the UE does not perform retransmission with an excessive long delay time after CG transmission, or may allocate only a predetermined number of retransmissions. In the embodiment of FIG. 9, it is assumed that HARQ process IDs (HPIs) available when CG A is configured are set to 0, 1, and 2, and that HARQ mode B, in which a ConfiguredGrantTimer or a drx-HARQ-RTT-TimerUL is not started after an N-th retransmission (where N is a non-negative integer), is configured at the time of the CG transmission and retransmission. In the embodiment of FIG. 9, N is set to 2 as an example (930). Thereafter, the UE may perform CG transmission 900 by using a transmission resource of the CG, and may start a ConfiguredGrantTimer 901 at a start time point of a first symbol on which the CG is transmitted. In addition, the UE may start a drx-HARQ-RTT-TimerUL 902 at a first symbol immediately after an end time point of a PUSCH in which the CG transmission is performed. If a CG bundle is configured and a CG resource is repeated by using multiple PUSCH physical channels, the UE may start the drx-HARQ-RTT-TimerUL at a first symbol immediately after a time point at the end of a corresponding bundle transmission, based on the first transmission or the last transmission of the bundle depending on whether drx-LastTransmissionUL is configured. Thereafter, the base station may allocate a retransmission resource for the corresponding CG transmission 900 (910). Such a retransmission of the CG transmission may be configured when a CS-RNTI is used and a DCI message transmitted on a PDCCH physical resource has NDI=1. Since this is a first retransmission resource and an N value of 2 has not yet been reached, the UE may start a ConfiguredGrantTimer 911 at a start time point of a first symbol on which a retransmission resource of the CG is transmitted. In addition, the UE may start a drx-HARQ-RTT-TimerUL 912 at a first symbol immediately after an end time point of a PUSCH on which the retransmission resource of the CG is transmitted. If a CG bundle is configured for a CG retransmission resource, so that transmission is repeated by using multiple PUSCH physical channels, the UE may start the drx-HARQ-RTT-TimerUL at a first symbol immediately after a time point at the end of a corresponding bundle transmission, based on the first transmission or the last transmission of the bundle depending on whether drx-LastTransmissionUL is configured. Thereafter, the base station may allocate a retransmission resource 920 for a first retransmission 910 of the corresponding CG. Such a retransmission of the CG transmission may be configured when a CS-RNTI is used and a DCI message transmitted on a PDCCH physical resource has NDI=1. Since this is a second retransmission resource and an N value of 2 has been reached, the UE may not start a ConfiguredGrantTimer 921 at the start time point of the first symbol on which the retransmission resource of the CG is transmitted. In addition, the UE may not start a drx-HARQ-RTT-TimerUL 922 at the first symbol immediately after the end time point of the PUSCH on which the retransmission resource of the CG is transmitted.

In the embodiment of FIG. 9, it is assumed that in a configuration of HARQ mode B, both the ConfiguredGrantTimer and the drx-HARQ-RTT-TimerUL are not started after N retransmissions. However, it is also possible that only at least one of the two timers is not started. Thereafter, when an initial transmission using a CG resource is performed, the number of retransmissions may be initialized to 0. In addition, the N value may be configured for the UE by the base station according to each CG configuration.

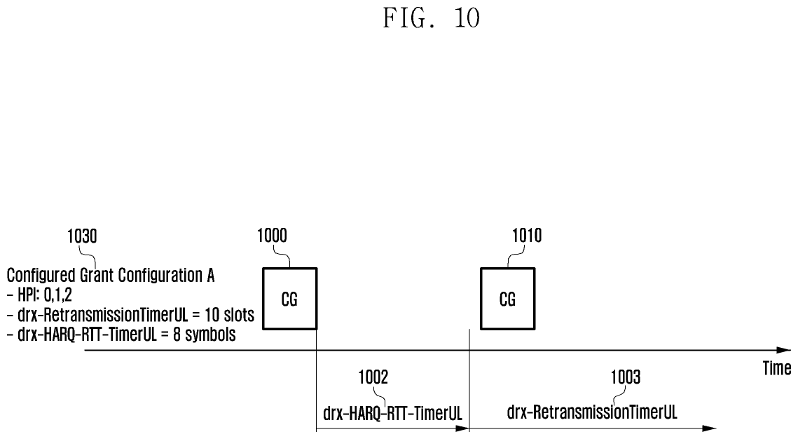

FIG. 10 is a diagram illustrating a configured grant transmission operation scheme according to an embodiment of the disclosure.

A configuration for a CG, excluding information on a location of a resource configured when the CG is activated, may be included in CG Config of an RRC message and transmitted by a base station to a UE. When data to be transmitted by a configured CG resource has a short transmission time requirement such as in motion control, high-speed multimedia, XR, or URLLC, performing retransmission after transmission through the CG may not satisfy the transmission time requirement. In this case, the base station may not allocate a retransmission resource so that the UE does not perform retransmission with an excessive long delay time after CG transmission, or may allocate only a predetermined number of retransmissions. In addition, due to transmission time requirements, retransmission may need to be completed within a predetermined period of time. Such characteristics may vary depending on each traffic type, and may also differ for each logical channel or radio bearer through which the respective traffic is transmitted. When data of each logical channel has such a strict transmission time requirement, a specific CG that is configured to be usable by the logical channel may be configured. For such a specific CG, a value of drx-HARQ-RTT-TimerUL or drx-RetransmissionTimerUL, which is used only for the CG to meet requirements of data to be transmitted, may be configured by the base station. In the embodiment of FIG. 10, it is assumed that HARQ process IDs (HPIs) available when CG A is configured are set to 0, 1, and 2, and that the value of drx-RetransmissionTimerUL is 10 slots and the value of drx-HARQ-RTT-TimerUL is 8 symbols in the configuration of the CG. In such a case where a drx-RetransmissionTimerUL or a drx-HARQ-RTT-TimerUL is configured in the CG configuration in this manner, the UE may ignore the value of drx-Retransmission TimerUL or drx-HARQ-RTT-TimerUL in a DRX configuration of a corresponding DRX group, and use the value specified in the CG configuration. If the CG resource is expected not to perform retransmission, the base station may set the value of drx-RetransmissionTimerUL to 0. In the case of a CG configured as such, the UE may perform CG transmission and start the drx-HARQ-RTT-TimerUL by applying the value configured in the CG configuration to a first symbol immediately after an end time point of a PUSCH in which the CG transmission is performed (1002). If a CG bundle is configured and a CG resource is repeated by using multiple PUSCH physical channels, the UE may start the drx-HARQ-RTT-TimerUL at a first symbol immediately after a time point at the end of a corresponding bundle transmission, based on the first transmission or the last transmission of the bundle depending on whether drx-LastTransmissionUL is configured. When the drx-HARQ-RTT-TimerUL expires, the UE may start a drx-Retransmission TimerUL 1003 by applying the value configured in the CG configuration.

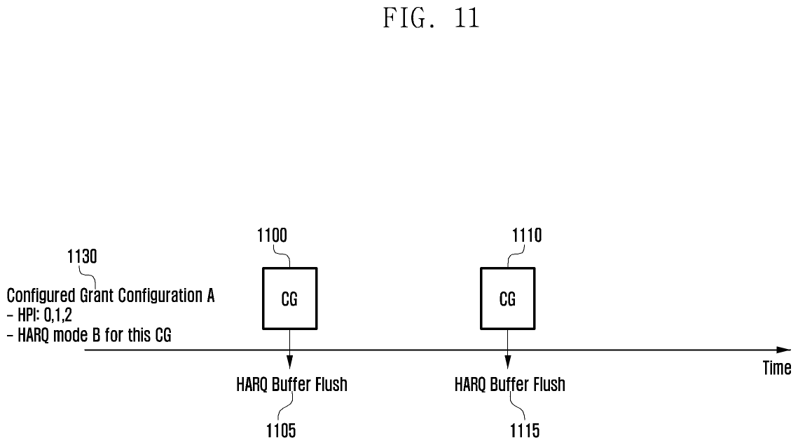

FIG. 11 is a diagram illustrating a configured grant transmission operation scheme according to an embodiment of the disclosure.

A configuration for a CG, excluding information on a location of a resource configured when the CG is activated, may be included in CG Config of an RRC message and transmitted by a base station to a UE. When data to be transmitted by a configured CG resource has a short transmission time requirement such as in motion control, high-speed multimedia, XR, or URLLC, performing retransmission after transmission through the CG may not satisfy the transmission time requirement. In this case, the UE may not allocate a retransmission resource after CG transmission. Therefore, if no further retransmission is performed after the initial transmission of the CG, the UE may flush an HARQ buffer for a corresponding CG transmission resource.

In the embodiment of FIG. 11, it is assumed that HARQ process IDs (HPIs) available when CG A is configured are set to 0, 1, and 2, and that HARQ mode B, in which an HARQ buffer is flushed after CG transmission, is configured (1130). Thereafter, the UE may perform transmission of a CG resource 1100. As described in another embodiment, when HARQ mode B is configured, the UE may not start a drx-HARQ-RTT-TimerUL or a ConfiguredGrantTimer. Further, according to an embodiment, the UE may flush the HARQ buffer of an HARQ process for the corresponding CG after the CG transmission (1105). The configuration of the HARQ mode B may be valid for all configured CG resources, and even after a subsequent CG transmission 1110, the UE may flush the HARQ buffer of the HARQ process for the corresponding CG (1115). In the embodiment of FIG. 11, it is assumed that the HARQ buffer is flushed immediately after the initial CG transmission, but the UE may also flush the HARQ buffer after a non-negative integer N of retransmissions. Thereafter, when an initial transmission using a CG resource is performed, the number of retransmissions may be initialized to 0. In addition, the N value may be configured for the UE by the base station according to each CG configuration.

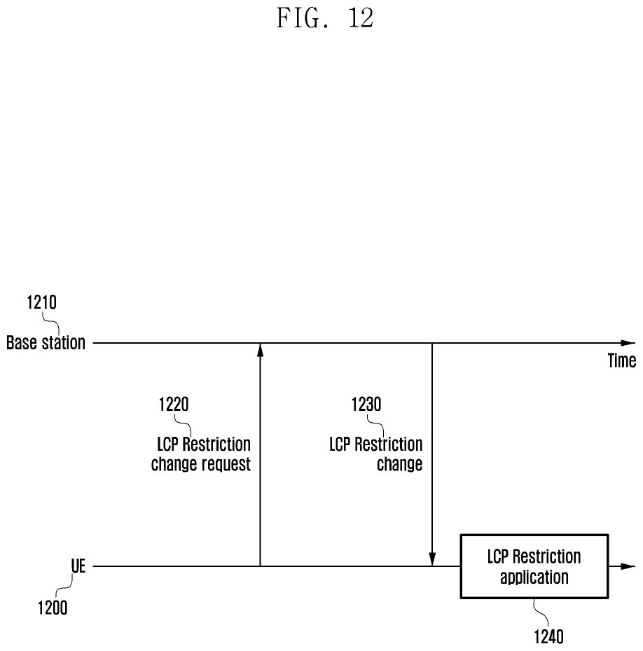

FIG. 12 is a diagram illustrating a logical channel prioritization (LCP) restriction change operation scheme according to an embodiment of the disclosure.

In a 5th generation (5G) wireless communication system, a base station may allocate various types of resources according to service requirements of a UE. In particular, when data transmitted by the UE has a short transmission time requirement such as in motion control, high-speed multimedia, XR, or URLLC, the base station may allocate a CG resource which may be used by a logical channel which transmits such data. In this case, a DG may be used for transmission of other general data, and if data that is required to be transmitted using a CG is transmitted through a DG, the requirement may not be satisfied. Therefore, the base station may configure an LCP restriction, such as an allowedCG-List, to allow only a specific CG to be used by a logical channel which is to use a CG. In addition, since the logical channel cannot use a DG, the base station may configure allowedPHY-PriorityIndex to be p0 (low priority) or p1 (high priority), and may not allocate a DG having the configured physical layer priority (PHY priority) p0 or p1. However, if excessive traffic occurs at the UE or if the configured CG resource becomes unavailable due to de-prioritization by other resources, a UE 1200 may transmit, to a base station 1210, a message for requesting a change in the LCP restriction such as the allowedPHY-PriorityIndex (1220). In another embodiment, instead of a request by the UE 1200 to the base station 1210, the UE 1200 may transmit a scheduling status of the UE 1200 to the base station 1210. For example, when considering a status of data which has arrived at the UE 1200, if the currently configured LCP restriction cannot satisfy the transmission time requirement, the UE 1200 may use the message in step 1220 as a message for informing the base station 1210 of this situation. The status of the data which has arrived at the UE 1200 may include at least one of data volume at the UE 1200, the remaining time until a packet is discarded at a packet data convergence protocol (PDCP) layer, or a residence time of a packet arriving at the PDCP or a service data adaptation protocol (SDAP) layer. The LCP restriction change request message transmitted in step 1220 may be in the form of a MAC CE, a UE Assistance Information message, or another RRC message format. Thereafter, the base station 1210 may recognize that the UE 1200 may not properly process the data under the current LCP restriction, and may transmit a message for indicating the UE 1200 to change the LCP restriction (step 1230). The LCP restriction change message transmitted in step 1230 may be in the form of a MAC CE or an RRC reconfiguration message. Based on the received message, the UE may apply a new LCP restriction (step 1240).

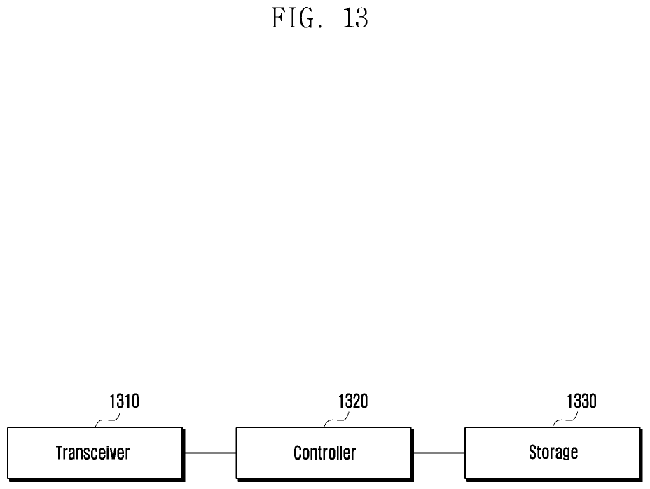

FIG. 13 illustrates a structure of a base station according to an embodiment of the disclosure.

Referring to FIG. 13, the base station may include a transceiver 1310, a controller 1320, and a storage 1330.

The transceiver 1310 refers to a base station receiver and a base station transmitter as a whole, and may transmit/receive signals with UEs, other base stations, or other network devices. The transmitted/received signals may include control information and data. The transceiver 1310 may transmit, for example, system information, synchronization signals, or reference signals to UEs. To this end, the transceiver 1310 may include an RF transmitter configured to up-convert and amplify the frequency of transmitted signals, an RF receiver configured to low-noise-amplify received signals and down-convert the frequency thereof, and the like. However, this is only an embodiment of the transceiver 1310, and the components of the transceiver 1310 are not limited to the RF transmitter and the RF receiver. The transceiver 1310 may include wired/wireless transceivers, and may include various components for transmitting/receiving signals. In addition, the transceiver 1310 may receive signals through a communication channel (e.g., a radio channel), output the same to the controller 1320, and transmit signals output from the controller 1320 through the communication channel. Furthermore, the transceiver 1310 may receive communication signals, output same to a processor, and transmit signals output from the processor to UEs, other base stations, or other network entities through a wired/wireless network.

The storage 1330 may store programs and data necessary for operations of the base station. In addition, the storage 1330 may store control information or data included in signals acquired by the base station. The storage 1330 may include storage media such as a ROM, a RAM, a hard disk, a CD-ROM, and a DVD, or a combination of storage media. In addition, the storage 1330 may store at least one of information transmitted/received through the transceiver 1310 and information generated through the controller 1320.

As used herein, the controller 1320 may be defined as a circuit, an application specific integrated circuit, or at least one processor. The processor may include a communication processor (CP) which performs control for communication and an application processor (AP) which controls upper layers such as application programs. The controller 1320 may control the overall operation of the base station according to the embodiments proposed in the disclosure. For example, the controller 1320 may control signal flows between the respective blocks to perform operations according to the above-described flowcharts. According to an embodiment of the disclosure, the controller 1320 may control the transceiver 1310 to generate configuration information for CG transmission and transmit the generated CG configuration information.

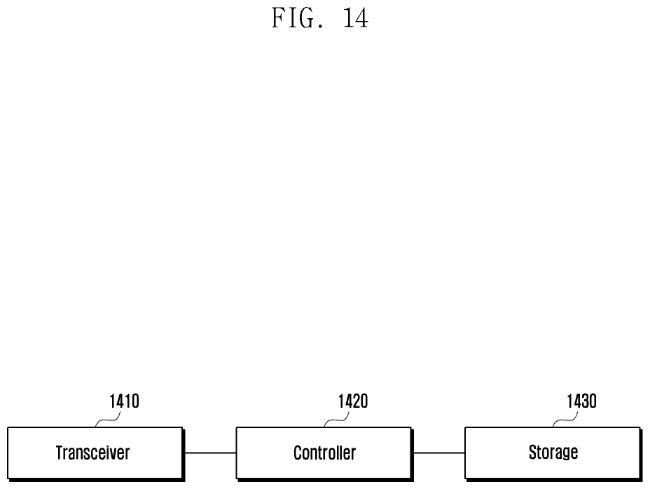

FIG. 14 illustrates a structure of a UE according to an embodiment of the disclosure.

Referring to FIG. 14, the UE may include a transceiver 1410, a controller 1420, and a storage 1430. The transceiver 1410, the controller 1420, and the storage 1430 may be operated according to the above-described communication methods of the UE. Components of the UE are not limited to the above-described example. For example, the UE may include a larger or smaller number of components than the above-described components. For example, the UE may include the transceiver 1410 and the controller 1420. Furthermore, the transceiver 1410, the controller 1420, and the storage 1430 may be implemented in the form of a single chip.

The transceiver 1410 refers to a UE receiver and a UE transmitter as a whole, and may transmit/receive signals with the base station, other UEs, and other network entities. The signals transmitted/received with base stations may include control information and data. The transceiver 1410 may receive, for example, system information, synchronization signals, or reference signals from the base station. To this end, the transceiver 1410 may include an RF transmitter configured to up-convert and amplify the frequency of transmitted signals, an RF receiver configured to low-noise-amplify received signals and down-convert the frequency thereof, and the like. However, this is only an embodiment of the transceiver 1410, and the components of the transceiver 1410 are not limited to the RF transmitter and the RF receiver. Also, the transceiver 1410 may include wired/wireless transceivers, and may include various components for transmitting/receiving signals. In addition, the transceiver 1410 may receive signals through a radio channel, output the same to the controller 1420, and transmit signals output from the controller 1420 through the radio channel. Furthermore, the transceiver 1410 may receive communication signals, output same to a processor, and transmit signals output from the processor to network entities through a wired/wireless network.

The storage 1430 may store programs and data necessary for operations of the UE. In addition, the storage may store control information or data included in a signal acquired by the UE. The storage 1430 may include storage media such as a ROM, a RAM, a hard disk, a CD-ROM, and a DVD, or a combination of storage media.

As used herein, the controller 1420 may be defined as a circuit, an application specific integrated circuit, or at least one processor. The processor may include a communication processor (CP) which performs control for communication and an application processor (AP) which controls upper layers such as application programs. The controller 1420 may control the overall operation of the UE according to the embodiments proposed in the disclosure. For example, the controller 1420 may control signal flows between the respective blocks to perform operations according to the above-described flowcharts. According to an embodiment of the disclosure, the controller 1420 may identify CG configuration information received from the base station. Also, the controller 1420 may determine, based on the CG configuration information, whether to operate any timer.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a terminal in a wireless communication system, the method comprising:
receiving a control message comprising configured grant (CG) configuration information from a base station;
based on the CG configuration information, identifying that information indicating deactivation of retransmission monitoring is configured;
receiving information on an uplink transmission through a physical downlink control channel (PDCCH), the information on the uplink transmission being associated with a configured scheduling-radio network temporary identifier (CS-RNTI) having a new data indicator (NDI) configured as 0; and
driving a discontinuous reception (DRX)-hybrid automatic repeat request (HARQ)-round trip time (RTT) timer after a first uplink data transmission based on the information received through the PDCCH.

2. The method of claim 1, further comprising:
based on the control message, identifying whether a bundle transmission for configuring multiple CG transmissions is configured; and
in case that the bundle transmission for configuring the multiple CG transmissions is configured, driving the DRX-HARQ-RTT timer in a first symbol after a last transmission of the bundle transmission is completed.

3. The method of claim 2, further comprising,
in case that information on a driving time point of the DRX-HARQ-RTT timer in the bundle transmission is not configured in the control message, driving the DRX-HARQ-RTT timer in a first symbol after a first transmission of the bundle transmission is completed.

4. The method of claim 1, wherein the driving of the timer comprises,
even in case that the information indicating the deactivation of the retransmission monitoring is configured, driving the DRX-HARQ-RTT timer after the first uplink data transmission.

5. The method of claim 1, further comprising, in case that the information indicating the deactivation of the retransmission monitoring is not configured, driving the DRX-HARQ-RTT timer corresponding to an HARQ process.

6. The method of claim 1, wherein, in case that the information indicating the deactivation of the retransmission monitoring is configured, the DRX-HARQ-RTT timer is not driven for an HARQ process corresponding to uplink data using the CG corresponding to the CG configuration information.

7. The method of claim 6, wherein, in case that the DRX-HARQ-RTT timer is not driven, a CG timer is not driven.

8. The method of claim 1, wherein the DRX-HARQ-RTT timer is not driven for an uplink transmission of a CG after the first uplink data transmission.

9. A terminal in a wireless communication system, the terminal comprising:
a transceiver; and
a controller configured to perform control to:
receive, through the transceiver, a control message comprising configured grant (CG) configuration information from a base station;
based on the CG configuration information, identify that information indicating deactivation of retransmission monitoring is configured;
receive information on an uplink transmission through a physical downlink control channel (PDCCH), the information on the uplink transmission being associated with a configured scheduling-radio network temporary identifier (CS-RNTI) having a new data indicator (NDI) configured as 0; and
drive a discontinuous reception (DRX)-hybrid automatic repeat request (HARQ)-round trip time (RTT) timer after a first uplink data transmission based on the information received through the PDCCH.

10. The terminal of claim 9, wherein the controller is configured to perform control to:
based on the control message, identify whether a bundle transmission for configuring multiple CG transmissions is configured; and
in case that the bundle transmission for configuring the multiple CG transmissions is configured, drive the DRX-HARQ-RTT timer in a first symbol after a last transmission of the bundle transmission is completed.

11. The terminal of claim 10, wherein the controller is configured to perform control to, in case that information on a driving time point of the DRX-HARQ-RTT timer in the bundle transmission is not configured in the control message, drive the DRX-HARQ-RTT timer in a first symbol after a first transmission of the bundle transmission is completed.

12. The terminal of claim 9, wherein, even in case that the information indicating the deactivation of the retransmission monitoring is configured, the DRX-HARQ-RTT timer is driven after the first uplink data transmission, and
wherein the DRX-HARQ-RTT timer is not driven for an uplink transmission for a CG after the first uplink data transmission.

13. The terminal of claim 9, wherein the controller is configured to perform control to, in case that the information indicating the deactivation of the retransmission monitoring is not configured, drive the DRX-HARQ-RTT timer corresponding to an HARQ process.

14. The terminal of claim 9, wherein, in case that the information indicating the deactivation of the retransmission monitoring is configured, the DRX-HARQ-RTT timer is not driven for an HARQ process corresponding to uplink data using the CG corresponding to the CG configuration information.

15. The terminal of claim 14, wherein, in case that the DRX-HARQ-RTT timer is not driven, a CG timer is not driven.
